(19) United States
(12) Patent Application Publication
(10) Pub. No.: US 2013/0038552 A1
(43) Pub. Date: Feb. 14, 2013

(54) METHOD AND SYSTEM FOR ENHANCING USE OF TOUCH SCREEN ENABLED DEVICES

(71) Applicants: Boris Kai-Tik Chan, Toronto (CA); Sundeep Singh Madra, Palo Alto, CA (US); Jonathan Mikhail, Toronto (CA); David Protasowski, Oshawa (CA); Sina Sojoodi, Toronto (CA)

(72) Inventors: Boris Kai-Tik Chan, Toronto (CA); Sundeep Singh Madra, Palo Alto, CA (US); Jonathan Mikhail, Toronto (CA); David Protasowski, Oshawa (CA); Sina Sojoodi, Toronto (CA)

(73) Assignee: XTREME LABS INC., Toronto (CA)

(21) Appl. No.: 13/568,543

(22) Filed: Aug. 7, 2012

Related U.S. Application Data
(60) Provisional application No. 61/521,159, filed on Aug. 8, 2011.

(51) Int. Cl. G06F 3/041

(52) U.S. Cl. 345/173

(57) ABSTRACT

A method is provided for processing touch gesture inputs received on a mobile device. After a touch gesture input is received and abstracted on the mobile device, it is determined whether the touch gesture input is recognized by the mobile device and meets a predetermined threshold. Provided the touch gesture input passes these tests, it is further determined whether the recognized touch gesture input is native to the mobile device. If non-native, a universal gesture library is queried to find an emulation gesture that is equivalent to the touch gesture input. The emulation gesture can then be made available to an application on the mobile device. A programmed mobile device is also provided for processing touch gesture inputs.

### CROSS REFERENCE TO RELATED APPLICATION

This application claims priority from U.S. Provisional Application No. 61/521,159 filed on Aug. 8, 2011, which is incorporated by reference in its entirety herein.

### TECHNICAL FIELD

The invention is related to methods and systems for enhancing the use of gestural input to a device via a touch-enabled screen.

### BACKGROUND

Touch enabled and touch sensitive screens have become widely adopted in electronic and computing devices, particularly in mobile devices such as smartphones and music players where they provide an intuitive method of human-computer interaction in an input/display area that is small due to being an integral part of mobile device. Intuitiveness arises from physical action metaphors such as pressing an on-screen button to activate a process; pressing on and dragging an object to move it; pinching an on screen object with two or more fingers before performing an expanding or contracting motion, in order to resize or otherwise manipulate the object; and so forth. These actions are often performed on virtual objects that themselves are physical metaphors. Depending on the device and software running on it, single or multiple points of contact (often called multi-touch) may be available.

Gestures in the context of computing devices refer to the actions of styli, fingers or similar devices on a touch sensitive surface, in order to convey instructions to software enabled to receive such instructions. While gestures are a ubiquitous user interface replacing common discrete, dedicated input methods such as a keyboard and mouse, they vary greatly in type. Particularly, mobile devices differ in the quantity and types of gestures supported.

Touch screen devices support a variety of types of defined gestures. These are not standardized across devices or device categories, posing a challenge for developers wishing to provide full-featured software for these devices (e.g. using touch for navigation or interaction). The typical response at present is either highly specialized custom programming for each device type/category, dumbing down of software to make use of only a limited range of the most commonly-supported gestures, and/or completely ignoring older devices (or tolerating a poorer user experience on such devices).

It would be desirable to provide a smoother user experience by handling touch gesture input at the software level, allowing for a broader range of supported and emulated gestures for devices.

### SUMMARY

According to a first aspect of the invention, a method is provided for processing touch gesture inputs received on a mobile device. A touch gesture input is received and abstracted on the mobile device. If it is determined that the touch gesture input is recognized by the mobile device and meets a predetermined threshold, it is further determined whether the recognized touch gesture input is native to the mobile device. If non-native, a universal gesture library is queried to find an emulation gesture that is equivalent to the touch gesture input. Finally, the emulation gesture is made available to an application on the mobile device.

Behavior instructions may be further made available to the application for the emulation gesture. For example, the behavior instructions may include instructions for a scrolling behavior, for drawing a picture, for manipulating or interacting with a document or an object displayed on a screen on the device, or for interacting with a virtual key or button on a screen on the device. Further, the behavior instructions may include instructions governing or changing other behavior. For example, the behavior instructions may include instructions for stopping, slowing or cancelling another behavior or process; or for accelerating a behavior.

In one embodiment, the application is a browser. The touch gesture input may be a touch gesture input received through the browser. The touch gesture input may alternatively be received though another application (the application may or may not be the same application in which the behavior is exhibited).

If the touch gesture input is recognized and is native, the method may also include determining by querying the universal gesture library whether there is an override for the native gesture, and making the override gesture available to the application. This override gesture may be a modified version of the native gesture (e.g. an accelerated version of the native gesture).

According to a second aspect of the invention, a programmed mobile device is provided for processing touch gesture inputs. The device has resident software. The software is programmed for receiving and abstracting a touch gesture input on the mobile device. The software is further programmed for determining that the touch gesture input is recognized by the mobile device and meets a predetermined threshold. The software is further programmed for determining whether the recognized touch gesture input is native to the mobile device. If non-native, the software is programmed to query a universal gesture library to find an emulation gesture that is equivalent to the touch gesture input. Finally, the software is programmed for making the emulation gesture available to an application on the mobile device.

The universal gesture library may be resident on the mobile device, or may be remotely stored and accessed by query from the mobile device.

### BRIEF DESCRIPTION OF DRAWINGS

FIG. 1 is a flow diagram illustrating the core logic involved in determining gesture control instructions and support for gestures whether or not those gestures are native to the device.

FIG. 2 is a conceptual diagram illustrating the relationship between the software and different types of gestures supported on different types of mobile devices.

### DETAILED DESCRIPTION

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviors that other programming languages might perform during compilation. JavaScript, PHP, Perl, Python and Ruby are examples of dynamic languages. Additionally computer code may also be written using a web programming stack of software, which may mainly be comprised of open source software, usually containing an operating system, Web server, database server, and programming language. LAMP (Linux, Apache, MySQL and PHP) is an example of a well-known open-source Web development platform. Other examples of environments and frameworks in which computer code may also be generated are Ruby on Rails which is based on the Ruby programming language, or node.js which is an event-driven server-side JavaScript environment.

The program code may execute entirely on the client device, partly on the client device, as a stand-alone software package, partly on the client device and partly on a remote computer or entirely on the remote computer or server. In the latter scenario, the remote computer may be connected to the client device through any type of network, including a local area network (LAN) or a wide area network (WAN), or the connection may be made to an external computer (for example, through the Internet using an Internet Service Provider).

It will be understood that the device enables a user to engage with an application using the invention, and includes a memory for storing a control program and data, and a processor (CPU) for executing the control program and for managing the data, which includes user data resident in the memory and includes buffered content. The device may be coupled to an external video display such as a television, monitor, or other type of visual display, in addition to or as an alternative to an onboard display. Storage media may be onboard or external, such as a DVD, a CD, flash memory, USB memory or other type of memory media or it may be downloaded from the internet. The storage media can be inserted to the device where it is read. The device can then read program instructions stored on the storage media and present a user interface to the user.

In preferred embodiments, the device is fully mobile and portable (e.g. a laptop, a notebook, a cellular phone, a smartphone, a PDA, an iPhone, an iPad, an iPod, an e-book reader e.g. Kindle, Kindle DX, Nook, etc.), although it will be appreciated that the method could be applied to more fixed (non-portable) computers and related devices with appropriate modifications (e.g. a personal computer (PC), corporate PC, a server, a PVR, a set-top box, wireless enabled Blu-ray player, a TV, a SmartTV, wireless enabled Internet radio) and other such devices that may be used for the viewing and consumption of content whether the content is local, is generated on demand, is downloaded from a remote server where it exists already or is generated as a result.

The device has a touch-sensitive display with a graphical user interface (GUI), one or more processors, memory and one or more modules, programs or sets of instructions stored in the memory for performing multiple functions. Using the touch screen, the user interacts with the GUI primarily through finger contacts and gestures on the touch-sensitive display. In addition, one or more buttons, keys, keypads, keyboards, track devices, microphones, etc., and other input mechanisms may be provided.

In some embodiments, the in-built functions may include providing maps and directions, telephoning, video conferencing, e-mailing, instant messaging, blogging, digital photography, digital videoing, web browsing, digital music playing, and/or digital video playing. Instructions for performing these functions may be included in a computer readable storage medium or other computer program product configured for execution by one or more processors.

It should be understood that although the term “application” has been used as an example in this disclosure, in essence the term may also apply to any other piece of software code where the embodiments of the invention are incorporated. The software application can be implemented in a standalone configuration or in combination with other software programs and is not limited to any particular operating system or programming paradigm described here. Thus, this invention intends to cover all applications and user interactions described above as well as those obvious to the ones skilled in the art.

Several exemplary embodiments/implementations of the invention have been included in this disclosure. There may be other methods obvious to persons skilled in the art, and the intent is to cover all such scenarios. The application is not limited to the cited examples, but the intent is to cover all such areas that may be benefit from this invention.

The source device (or server) where content is located or generated and recipient device (or client) where content is consumed may be running any number of different operating systems as diverse as Microsoft Windows family, MacOS, iOS, any variation of Google Android, any variation of Linux or Unix, PalmOS, Symbian OS, Ubuntu or such operating systems used for such devices available in the market today or the ones that will become available as a result of the advancements made in such industries.

Many modern mobile devices provide for receiving user input from a touchscreen. In this application, touch enabled screens or touch screens refer to all types of touch sensitive surfaces on a device. There are several methods for touchscreen implementations e.g. a capacitive screen or a resistive screen. Touchscreens are increasingly popular as a human interface device (HID) technology, for example to replace the computer mouse, and provide for a unique way of interacting with the computer or device. There are several different technological ways of implementing this, some of the more popular methods widely used in the industry are described below.

Resistive touchscreens are touch-sensitive displays composed of two flexible sheets coated with a resistive material and separated by an air gap or microdots. When contact is made to the surface of the touchscreen, the two sheets are pressed together. There are horizontal and vertical lines on these two screens that when pushed together, register the precise location of the touch. Because the touchscreen senses input from contact with nearly any object (finger, stylus/pen, palm) resistive touchscreens are a type of “passive” technology.

Capacitive sensing is a technology based on capacitive coupling that is used in many different types of sensors, including those for detecting and measuring: proximity, position or displacement, humidity, fluid level, and acceleration. Capacitive sensors are used in devices such as laptop trackpads, MP3 players, computer monitors, cell phones and others. Capacitive sensors are used widely for their versatility, reliability and robustness, providing a unique human-device interface and cost reduction over mechanical switches. Capacitive touch sensors now feature prominently in a large number of mobile devices e.g. Smartphones, MP3 players etc.

In surface capacitance, only one side of the insulator is coated with a conductive layer. A small voltage is applied to the conductive layer, resulting in a uniform electrostatic field. When a conductor, such as a human finger, touches the uncoated surface, a capacitor is dynamically formed. The sensor's controller can determine the location of the touch indirectly from the change in the capacitance as measured from the four corners of the panel. This kind of touchscreen has no moving parts, therefore it is moderately more durable but has limited resolution. It is also prone to false signals from parasitic capacitive coupling, and needs calibration during manufacturing. It is therefore most often used in simple applications such as industrial controls and kiosks.

Although a few exemplary touchscreen technologies are described above, the methods and systems described in this application are intended to work with any kind of a touchscreen technology.

Current methods define simple ways of using the touchscreen for this interaction through gestures. A gesture refers to a motion used to interact with multipoint touchscreen interfaces. Touchscreen devices may employ gestures to perform various actions. Some examples are given below:

On iOS devices (iPhone, iPad etc.), a one-finger “swipe” may be used to unlock the device. On Blackberry OS6 devices, one-finger swipe may be used to scroll through different menus on the homescreen and other screens within the OS.

A “pinch” refers to pinching together the thumb and finger, and may be used to zoom out on an image.

A “reverse pinch” (sometimes also called “unpinch”) refers to spreading two fingers (or thumb and finger) apart, and may be used to enlarge a picture or zoom in on an image.

The present invention disclosed herein provides methods and systems that mitigate at least some of the limitations of current methodology to provide a method by which types of gestures natively supported by software can be extended to additional predefined or user-defined gestures.

The method and system of the present invention defines add-on software that expands the capabilities of built-in gesture support in electronic devices. The add-on software queries the base software of its gesture capability and determines which gestures are native. The add-in software may make available additional pre-defined gestures such that a greater set of gestures is available.

Although the present invention has application in touch enabled software in general, a preferred embodiment is in user interfaces found in mobile devices.

In a preferred embodiment, add-on software is installed in association with anything that can render web pages (e.g. browser). Subsequently, the add-on queries the operating system as to what gestures are available, enabling gestures not found in the browser which can be supported by the available hardware; certain gestures may not be supported, such as in the case of gestures requiring multi-touch where hardware supports merely single touch. The add-on also queries the operating system regarding the touch screen resolution and dimensions, in order to map the area according to anticipated input. One advantage of the invention is to support older devices and newer devices with a single application to enable a more uniform user experience.

Gestures already supported by the device may be detected by a combination of methods, including: (a) APIs that poll native support, (b) predetermined capabilities of any given browser version and (c) additional hardware and software capabilities as determined by an established and maintained database of devices.

Gestures are touch events that are encapsulated within a time period. An arbitrary amount of gestures can be created and provided across all browsers. This library (e.g. a Javascript library) provides the means to use additional gestures in applications and have them work across all platforms that have touch based control. Hence the present invention aims to provide universal gesture support through a Universal Gesture Engine (UGE).

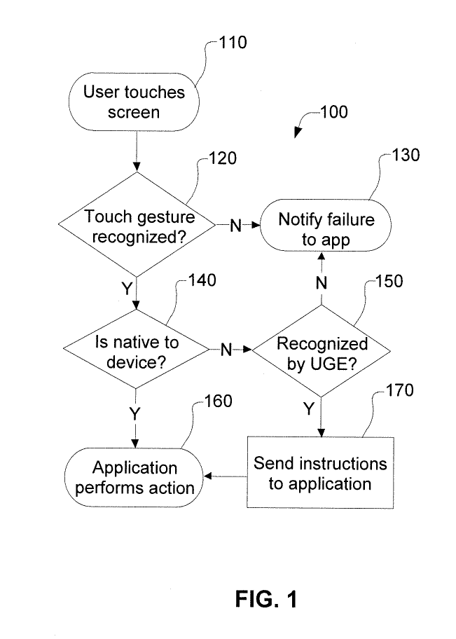

FIG. 1 illustrates the core logic involved in determining gesture control and support for gestures whether or not those gestures are native to the device. In order to tackle the issue of gesture support, the software follows a process to understand the gestures that are (1) supported natively; (2) not supported natively but capable of emulation (i.e. to “fake the gesture”); and (3) unable to be handled (allowing for work-arounds, e.g. alternative simpler browser view with reduced interactivity).

Referring to FIG. 1, the following method 100 enables universal gesture support. The following logic described for the present invention is performed by the add-on software.

Constantly listening for requests, software action is triggered when a touch-sensitive screen on the device is touched 110. A first test determines whether the gesture is recognized 120. If not, a failure action is performed 130. For example, an error message may be displayed. If the gesture is recognized, a second test is performed to determine whether the gesture is native to the client device 140. These two tests may be closely related such that they may be performed simultaneously. If, in the second test, the gesture is recognized as native to the client device, the application (such as a web browser) performs the action directly 160. If the gesture is not native, the present universal gesture engine (UGE) attempts to match the gesture against a library 150. If the gesture is not recognized by the UGE, a failure action 130 is performed such as an error message that may be displayed. If the gesture is recognized by the UGE as one in its set, specific instructions are sent to the browser 170, emulating the action sought by the gesture using one or more of a combination of existing methods. The browser then performs the action (rather than the OS level which is where gestures are typically processed), providing a better experience to the end-user.

Taking a simple example, the user may wish to draw a circle. This gesture may not be provided natively, but the software can detect a circle and provide that as an event for the user.

The present invention attempts to enhance use of touch-enabled devices particularly at the application level. The present invention will permit an application to implement (or receive) gestures that are not natively implemented on the operating system or hardware of a specific device. For example, if a gesture is theoretically supported by the hardware, but the software does not expose this as an API, the gesture can still be abstracted and handled.

Because the present invention operates on gestures at the application level, the same gesture can more easily do different things in different applications that are running on the same type of device.

Further because the present invention will attempt to translate gestures and emulate commands or input which the operating system of a particular device can receive, it is less likely to reject input or generate error messages compared to devices which can only deal with natively supported gestures. In other words, gestures are captured at the application or platform level, not only at the operating system level.

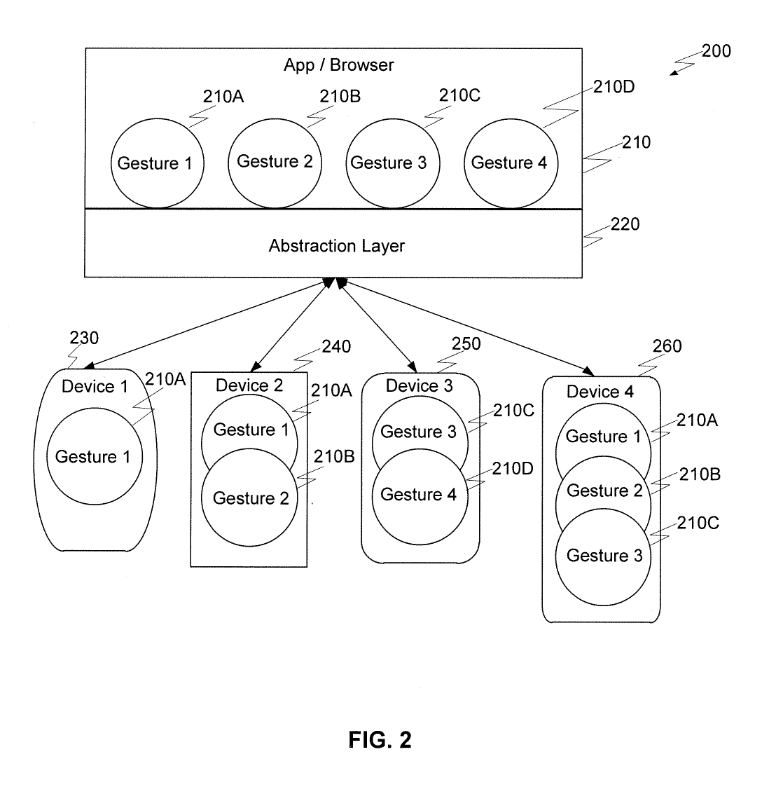

FIG. 2 is a conceptual diagram illustrating the relationship between the software and the different types of gestures supported on different types of mobile devices. The software 200 adds an abstraction layer 220 to a pre-existing application (such as a browser) 210. The application is programmed to respond to various gesture types (Gestures 1-4 illustrated) 210A-210D. In reality, only a subset of these gestures is supported on each type of device. The devices using the software are not equipped to support each and every one of these gestures. Device 230 supports only gesture 210A. Device 240 supports only gestures 210A, 210B. Device 250 supports gestures 210C and 210D. Device 260 supports gestures 210A, 210B, and 210C. Each of these can be handled smoothly because the native capabilities of the devices have been polled (or are otherwise known) to the software 200. Further, as described above, the software can help the devices to stretch their capabilities by providing emulation gestures where possible, and/or a simplified interface can be provided so that the user does not experience the frustration of gestures that are misunderstood or that appear to do nothing.

In an alternative embodiment of the present invention, the method and system may be used to over-ride native behaviour of a mobile device. For example the present invention could change the acceleration behaviour of a scroll gesture, even where scroll gestures were natively supported.

The framework can also be used for custom and user-defined gestures, as well as left-handed user support. Further, using thresholds in the software can weed out unintentional or accidental gestures (e.g. pocket dialing or unintentional swipes which do not exceed the sensor thresholds). The software can also resolve ambiguities where several possible gestures could be interpreted (using gesture abstraction to resolve the ambiguity in the same way it would otherwise be resolved in the OS layer).

The intent of the application is to cover all such combinations and permutations not listed here but that are obvious to persons skilled in the art. The above examples are not intended to be limiting, but are illustrative and exemplary.

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and equivalents obvious to those familiar with the art.

What is claimed is:

1. A method of processing touch gesture inputs received on a mobile device, comprising:
receiving and abstracting a touch gesture input on the mobile device;
determining that the touch gesture input is recognized by the mobile device and meets a predetermined threshold;
determining whether the recognized touch gesture input is native to the mobile device;
if non-native, querying a universal gesture library to find an emulation gesture that is equivalent to the touch gesture input; and
making the emulation gesture available to an application on the mobile device.

2. The method of claim 1, further comprising making behavior instructions available to the application for the emulation gesture.

3. The method of claim 2, wherein the behavior instructions include instructions for a scrolling behavior.

4. The method of claim 3, wherein the behavior instructions include instructions for accelerating a behavior.

5. The method of claim 2, wherein the behavior instructions include instructions for drawing a picture.

6. The method of claim 2, wherein the behavior instructions include instructions for manipulating or interacting with a document or an object displayed on a screen on the device.

7. The method of claim 2, wherein the behavior instructions include instructions for interacting with a virtual key or button on a screen on the device.

8. The method of claim 2, wherein the behavior instructions include instructions for stopping, slowing or cancelling another behavior or process.

9. The method of claim 1, wherein the application is a browser.

10. The method of claim 1, wherein the touch gesture input is a touch gesture input received through a browser.

11. The method of claim 1, wherein the touch gesture input is received through the application.

12. The method of claim 1, further comprising, if native, determining by querying the universal gesture library whether there is an override for the native gesture, and making the override gesture available to the application.

13. The method of claim 12, wherein the override gesture is a modified version of the native gesture.

14. The method of claim 12, wherein the override gesture is an accelerated version of the native gesture.

15. A programmed mobile device for processing touch gesture inputs, the device having resident software for:
receiving and abstracting a touch gesture input on the mobile device;
determining that the touch gesture input is recognized by the mobile device and meets a predetermined threshold;
determining whether the recognized touch gesture input is native to the mobile device;
if non-native, querying a universal gesture library to find an emulation gesture that is equivalent to the touch gesture input; and
making the emulation gesture available to an application on the mobile device.

16. The device of claim 15, wherein the universal gesture library is resident on the mobile device.

17. The device of claim 15, wherein the universal gesture library is remotely stored and accessible by query from the mobile device.
